(19) United States
(12) Patent Application Publication
(10) Pub. No.: US 2004/0007143 A1
(43) Pub. Date: Jan. 15, 2004

(54) Custom rubber stamp member creating process

(76) Inventor: Brent Alan Baxter, San Francisco, CA (US)

Correspondence Address: Brent A. Baxter, 3946 Akmany Blvd., San Francisco, CA, 94132-3207, US

(21) Appl. No.: 10/192,881

(22) Filed: Jul. 9, 2002

(51) Int. Cl. B41K 1/00

(52) U.S. Cl. 101/327; 101/401.1

(57) ABSTRACT

A method for producing a custom rubber stamp member which utilizes either an etching/mold making process, or a method of additively drawing 3-D casting material directly to a rubber-like base. The “stamp unit” referred to below embodies one of two configurations—either a malleable substance which is readily etched into, or a rubber-like substance which will have cast making material superficially applied to it.

The steps are as follows:

(a) obtaining a desired image of intended stamp size as needed;

(b) image transfer means for transferring said image onto a stamp unit as needed;

(c) preparing a stamp unit for the application of cast making material;

(d) means of applying cast making material to said stamp unit;

(e) curing of said cast making material;

(f) separation of cured cast making material from stamp unit as needed;

(g) fastening of cured cast material to an operative stamping base.

### CROSS-REFERENCE TO RELATED APPLICATIONS

MAGNETIC STAMP MEMBER HOLDING AND POSITIONING DEVICE U.S. Pat. No. 09/465,997

### STATEMENT REGARDING FEDERALLY SPONSORED RESEARCH AND DEVELOPMENT

Not Applicable

### REFERENCE TO A MICROFICHE APPENDIX

Not Applicable

### BACKGROUND OF THE INVENTION

1. Field of the Invention

This invention relates to rubber stamp manufacture, either called “art stamps” or of the type used in general office stamping and printing in general; specifically this relates to a method for producing custom rubber stamps which is wholly designable by the user and, therefore, is especially attractive to those who enjoy creating their own stamp images.

2. Description of Related Art

Heretofore, conventional rubber stamps have only been offered which have pre-existing images on them. Accordingly, when consumers use these stamps they are limiting their creativity by what images are offered by conventional stamps. Consequently, the needs of a segment of the population who would desire to create their own stamp images, and feel pride in creative ownership of these images, are not being met with conventional stamps.

One type of stamp process allows for individuals to submit line artwork to a stamp manufacturer and have this image translated into a stamp for them. However, this type of method is either comparatively expensive or time consuming, or both.

Also, conventional stamp manufacturing devices require the use of bulky and/or costly equipment, of the type which the average individual would not easily be able to purchase, or readily make use of. Furthermore, many, if not all conventional stamp manufacturing processes utilize chemicals and materials which are harmful to the environment, or people.

### OBJECTS AND ADVANTAGES

Therefore, the main objective of this invention is to provide a process for individuals to create their own custom made rubber stamps which would display artworks or illustrations that they create.

Accordingly, several objects and advantages of my invention are: to provide a process for making high quality custom stamps, which require a minimum of effort and time. This invention offers a method whereby users can create and have total ownership of the images on those stamps and, consequently, where they can foster a pride in themselves and foster self esteem. Furthermore, this is a method which has a potential to produce an infinite amount images for the user, and which is environmentally safe, non-toxic, results in very few waste products .

While, I particularly envision this process as an arts and crafts activity, where individuals can easily create their own custom rubber stamp and which is suitable for most any age, I also see this stamp creating process as an educational tool which addresses a variety of instructional purposes, not the least being the process of stamp making, itself. In addition, business people wishing to create their own custom rubber stamp, may find my custom stamp making process invention very desirable.

It is also surmised that portions of this process may be useful, in providing a more environmentally friendly alternative in larger scale stamp manufacture, or printing.

Further objects and advantages of my invention will become apparent from a consideration of the drawings and ensuing descriptions of it.

List of Reference Numerals

10 original image for direct use or adaptation

20 intended size stamping image

22 transfer paper

24 transferred image

26 stamp mold making material

28 etching tool

30 etched line image

32 etched mold making material

34 liquid containment walls

36 brush applicator

38 liquid casting compound

40 measuring and dispensing spoon

42 cured casting compound/stamp member cast

44 self-adhesive magnetic strip

46 double-sided self-adhesive strip

48 operatively magnetic stamp member cast unit

50 stamp handle/base

52 ferromagnetic stamp handle/base

54 drawing stencil

56 stencil cutout

58 combination unit of #26 and #34

60 rubber-like stamp member cast base

62 stencil glide squeegee

64 stencil holder and squeegee runner

66 craft drawing tip

68 craft bottle

70 wax melting heated etching/embossing stylus

72 heat resistant etching screen

74 runoff collection tray

### BRIEF DESCRIPTION OF THE DRAWINGS

Please note for the interest of clarity, all preferred embodiments of the invention will be described, by way of example only, in FIGS. 1-17, with reference to the accompanying drawings wherein:

FIG. 1 is a flow chart of the basic incisive process for creating a stamp of this invention; in sum, it is a process which utilizes etching into a rubber stamp mold material.

FIG. 2 is an example of preparing an image of the desired actual stamp size 20, either through direct drawing, stencil, tracing, copy reduction, computer generated images, or any conventional reproduction means.

FIG. 3 is a perspective drawing of the image being transferred onto the stamp mold medium using transfer paper 22.

FIG. 4 is a perspective view showing the transferred image being etched, by directly re-drawing into the stamp mold medium using an etching/embossing tool 28.

FIG. 5 is a perspective view detailing an image being drawn with a heated etching/embossing tool 70 into the wax-like mold making material 26 where a heat resistant screen apparatus 72 and a runoff collection tray 74 (if desired) are placed underneath.

FIG. 6 is a perspective view showing the liquid containment walls 34 being placed over the stamp mold making material 26.

FIG. 7 is a perspective view of a pre-fabricated combination unit including containment walls 34 and mold making material 26.

FIG. 8 is a perspective view showing one suggested method of applying liquid casting compound 38. In this instance said liquid casting compound is being painted onto the etched stamp mold making material 26, although many forms of application are feasible and appropriate.

FIG. 9 is an illustration of the curing time necessitated.

FIG. 10 is a perspective view showing the cured casting compound 42 of the stamp member being removed from the stamp mold, now referred to as a stamp member cast 42.

FIG. 11 is an exploded perspective view showing the stamp member cast 42 being attached to a stamp handle/base 50. In this image the form of adhesive is shown as a strip of double-sided adhesive tape 46, although any chosen form of adhesive will work.

FIG. 12 shows the how a drawing stencil 54 can be placed over the stamp mold making material 26 for use as an etching guide.

FIG. 13 shows how a drawing stencil 54 is used to etch images onto the mold making material 26 (optional heated etching/embossing stylus 70 and related wax etching elements not shown).

FIG. 14 shows how a craft drawing tip 66 is used to direct-draw 3-dimensional images onto a stamping surface.

FIG. 15 shows how a craft drawing tip 66 is used to direct-draw 3-D images utilizing a stencil system.

FIG. 16 shows how a stencil glide squeegee 62 is RUN over the drawing stencil 54 to direct-draw images onto a stamping surface to create an even stamping surface. Image also shows the use of a stencil holder and squeegee runner 64.

FIG. 17 is a flow chart of the additive process for creating a rubber stamp of this invention; in sum, it is a process which uses the direct application of a three-dimensional liquid casting compound 38 onto a rubber-like stamp member cast base 60.

FIG. 18 shows an illustration depicting a magnetic form of stamp member fastening of which this invention can be alternatively employ.

### DETAILED DESCRIPTION OF THE PREFERRED EMBODIMENT

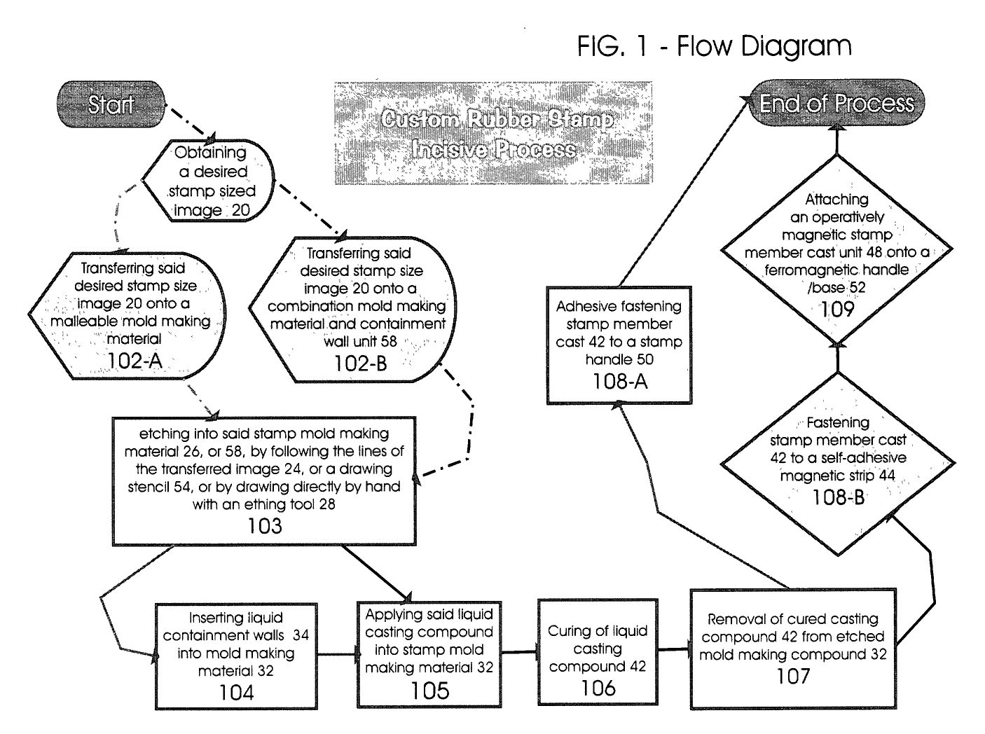

FIG. 1 illustrates a flow diagram of the preferred embodiment of a method for producing a custom stamp member of this invention. This is a process which utilizes etching into a rubber stamp mold material. Consequently, the process involves cutting an image (via a form of etching) into a stamp mold making material and then filling the incised recesses of said material with a rubber-like cast material 60. Enough material should be laid down to not only fill the incised recess, but to also allow for a thickness above the surface of the mold material which will result in an eventual stamp member cast base; this additional “thickness” of material, when removed from the cast, will provide a platform which supports the raised ink receiving surfaces of a rubber stamp. It should be noted that the removed stamp member cast will provide a reverse-image from what was incised into the material, because of mold and cast dynamics. However, since the stamp receiving raised members of any rubber stamp, need also be reversed (where the ink from a stamp is transferred back and “righted” onto an intended target surface), any image that is incised, or drawn, into the mold making material does not have to be altered in any way. Finally, as will be explained below, the material used as a mold making material should be easily etched into so as to provide negligible resistance to any etching action; such a material should allow the user to virtually “draw-etch” an image directly into the mold-making material; as a result, it will both retain “the feel of drawing” and produce smoother incised lines.

According to the flow diagram in FIG. 1, the detailed steps of the preferred embodiment of the custom stamp member manufacturing process are reported as follows:

(1) obtaining a desired size stamp image 20, as shown in block 101;

(2) transferring said desired stamp size image 20 onto a malleable mold making material 26, which has the characteristic of being easily etched into, yet holds its general form, as shown in block 102-A;

(3) etching into said stamp mold making material 26, or 58, by following the lines of a transferred image 24 with an etching tool 28 (by using a drawing stencil 54, a wax melting heated etching/embossing stylus 70, direct drawing, or by chemical etching), as shown in block 103;

(4) inserting liquid containment walls 34, designed to hold the liquid casting compound 38, poured onto the stamp mold making material 26, as shown in block 104;

(5) applying said liquid casting compound 38 into said etched mold making material 32, as shown in block 105;

(6) curing of said casting compound 42 as shown in block 106;

(7) removing the cured casting compound 42, hereby referred to as the stamp member cast 42, from the etched stamp mold making material 32, as shown in block 107;

(8) fastening the stamp member cast 42 to a stamp handle base 50; as shown in block 108-A;

The following process modifications should be noted:

a. The user may wish to make use of a combination mold making and liquid containment unit 58, as shown in block 102-B; this will reduce the amount of steps involved.

b. Also the user may desire to fasten the stamp member cast 42, to a self adhesive magnetic strip 44; this resulting “operatively magnetic stamp member cast” 48, can then be removably attached to a ferromagnetic metallic handle/base 52; While this alternative will increase the amount of steps involved in the process, it will also allow the rubber stamp to gain the advantages of repositionability, removability and any benefit afforded a magnetic attachment, as shown in blocks 108-B and 109;

c. Finally, the user may wish to etch/draw directly into the stamp mold making material 26 without using any form of image aid, thus the user will begin the process at the third step, as shown in block 103.

In step (1) if using an original image 10, a desired size stamp image 20 may be obtained by any means such as, but not limited to directly drawing, stencil, re-tracing an existing same size image, using an image size adjustable copy machine, computer and printer, or any means of creating an original, or reproduction of a desired size, or any combination thereof.

In step (2) if using an original image of correct size, the desired size stamp image 20 can be accomplished by re-tracing same lines of said desired stamp image 20 through a transfer a paper 22 onto a stamp mold making material 26, to result in a transferred image 24.

However, if using a drawing stencil 54, the initial use of the stencil image begins here, due to the dual nature of the drawing stencil 54, which acts as both an image and a transfer vehicle, thereby eliminating the need for using a transfer paper 22; However, if drawing directly onto the stamp mold making material 26, then the user will begin the process in the next step.

In step (3), if using the transfer paper method, the preferred method of etching is accomplished by “drawing” through the lines of the existing transferred image 24 using an etching tool 28. However, if using a drawing stencil 54, the preferred method of transferring the image is by placing a stencil drawing stencil over the mold making material 26 and then etching directly into said mold making material 26 while following along a chosen edge of the stencil cutout 56 with said etching tool 28. Still, if the user has decided, not to use either of the above two methods and instead desires to begin drawing at this step, said user may begin the image creation process here by etching directly into the stamp mold making material 26.

Also, in step (3), said stamp mold making material 26 should have a malleable but stable characteristic, one which will hold a high definition reproduction of the transferred image 24 when etched into by an etching tool 28, yet will hold its own general form irrespective of the etching process. Preferred materials for the said stamp mold making material 26 are medium to firm soap-like materials, glycerin soaps, wax derivatives, wax and plaster hybrids materials, or soap-plaster composites. Soap-like materials meet the above conditions in a very satisfactory manner; however, wax is also a highly useable alternative and combination wax-plaster type molding compounds have proven to be highly effective etching mediums, as well as pure wax-derived version; wax derivatives have their own intrinsic benefits as will be detailed below. Finally, the above is intended to be recognized as suggestive and not limiting. Any number of materials can be utilized or combined to create a useable etchable medium.

Additionally in step (3), the preferred tool for etching into the stamp mold making material 26 is an etching type tool 28, preferably of the type used by embossers; although any drawing tool that is strong enough to easily move through such an etchable, material, as described above, will work. If using meltable wax-like substance as the material to be etched into, an appropriately heated embossing/etching instrument 28, will etch quite well. Finally a rotary type tool will also effectively function well using any non-melting mold making material 26 described above, to further facilitate the etching portion of this stamp making process.

In step (3) regarding a “meltable” etch, a wax-type material is suggested for use in creating the etching portion of this process; the best form of etching in this manner is one which provides a fluid “hot knife through butter” form of fluid line etching, for ease of drawing/etching and creating a smooth line. Wax usage will be further detailed below. And while a wax-derivative is suggested as the preferred meltable material, other materials which safely melt and provide no toxic fumes may also be readily employed. Again, it is sure that those skilled in the arts will be able to create many highly effective alternatives to be used as said stamp mold making materials 26.

The preferred method of line etching 30 in step (3) can be accomplished by either drawing completely through the required thickness of said mold making material 26, during the first pass, or by partially drawing through said mold making material 26, using a succession of passes, such that with each pass the user draws deeper lines into the said mold making material 26 until reaching the bottom of its thickness. Or alternatively, the user may employ any means, so as to create the appearance of a finished continuous line, such as perforating the mold making material 26 with a series of contiguous, overlapping or adjacent holes. Further still, the user may employ any variety of drawing methods, tools, or combinations intended to create any lines, points, and, or patterns, that are desired in the eventual stamp image. Drawing easily and directly through the mold making material 26, however, would provide the most natural and simplest drawing method.

Additionally in step (3), said mold making material 26 could utilize a color-code system changing from one color layer to another color layer, thereby providing a form of a etch “depth gauge” which would assist in obtaining a proper depth of etching. This dissimilar colored layer could also be of a much denser (etch-resistant) quality or material so as to impede further etching when the appropriate depth is reached. The latter case would provide a very effective method to maintain proper etch depth and consequently ensure a proper height of the eventual stamp member mold. While the above would be most beneficial for non-heated etching, such a color coding system would also be visually advantageous for meltable wax-like etching processes; in this case having a contrasting colored heat resistant etching screen 72 would provide additional etching clarity.

In step (5), it is preferred that the material, for the liquid casting compound 38, be an air curing, self vulcanizing liquid casting material which emits no harmful fumes, and non-toxic and results in a “rubber like” material. This same casting material must also cure to a low rebound, low compressibility, characteristic of a stamping member, one which will maintain a rubber-like rebound quality necessary for creating effective stamps. One preferred choice of casting medium which fits these qualities is latex rubber derivative, or a latex rubber composite material, which could be combined with other mixable materials, for best hybrid results. However, any safe, non-toxic low-to no fume compound which provides the appropriate “rubber-like” qualities should also work well enough to provide a useable alternative. Again, those skilled in the arts will undoubtedly be able to design a most ideal form of liquid casting compound 38.

Also in step (5), the favored method of applying said liquid is by applying said casting compound 38 in a single layer and only once. However, it may be that the process will require using a succession of layers depending upon the qualities of the applied casting compound, or it may required the “tapping out” of air bubbles etc. If utilizing a stencil system as detailed below, a squeegee apparatus may be utilized to even out and remove excess material. Nevertheless, any resulting technique to ensure best casting, depends solely on the material employed.

In step (6) the preferred method for the curing of the liquid casting material 38, is accomplished through self vulcanization. Since this is a process in which a liquid rubber casting compound 38 type is set by evaporation, then merely allowing the time necessary for the material to set is enough. The process can, however, be speeded up by using any of the various methods designed to aid in evaporation and are easily accomplished by those skilled in the arts. Still, one highly successful method worth mentioning and which is used with latex rubber components includes employing isopropyl rubbing alcohol to speed up the evaporation of water molecules in the liquid latex rubber. In addition, it should be noted, that if any other types of materials are used, there will, of course, be other processes requisite to facilitating the curing of such a stamp cast material 38. And again, those skilled in the arts should have no trouble in engaging in this process.

In step (7) the cured stamp member cast can be removed by first taking off the liquid containment walls 34 and then separating the two remaining materials, 32 and 42, respectively.

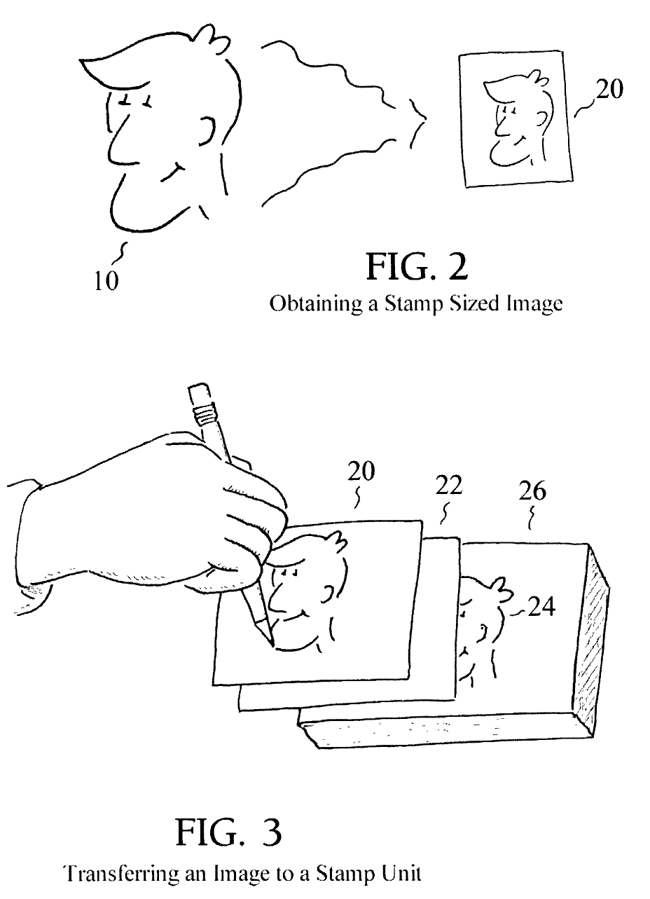

Referring to FIG. 2, any manner of image manipulation can be employed to create an intended stamp sized image. This is easily accomplished through computers, image re-sizing copiers, or even by hand. The tool used will depend upon the preferences of the user of this invention.

Referring to FIG. 3, transfer paper is a viable way to transfer an exact duplicate image onto the mold making material 26 in preparation for etching. When used the transfer paper 22 should be placed appropriately so as to assure that the image transfers from the original towards the intended location, that being the stamp mold making material 26. In order to do this, the “tinted” side of the transfer paper 22 should face said stamp mold making material 26. A stamp sized image 20 can be placed “face up” on top of the transfer paper 22, which is “sandwiched” between both the intended stamp sized image 20 and the mold making material 26. The user then “traces” over lines on the surface of said the stamp sized image 20 with a pencil, pen or any firm drawing instrument. The act of tracing creates friction and pressure which acts as a catalyst to transfer tint from the operative side of this transfer paper 22 onto the mold making material 26 creating a resulting transferred image 24.

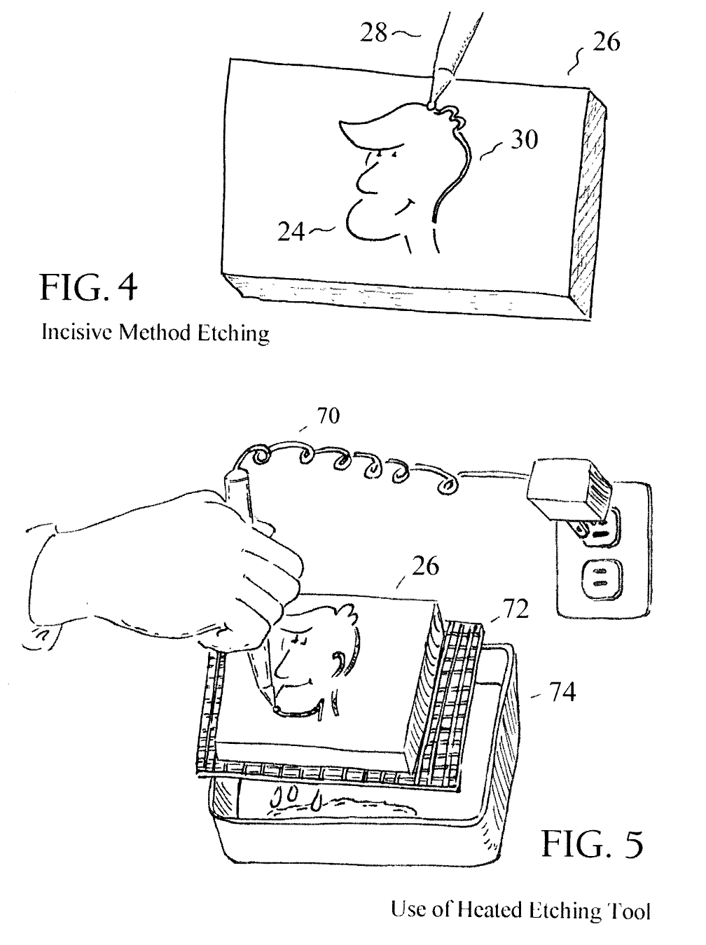

Referring to FIG. 4, the process of etching into the mold making material 26 has been detailed above in step (3) of FIG. 1.

Referring to FIG. 5, this method could utilize an appropriately heated drawing stylus 70 which provides an ease of etching into the mold making material 26, and where the wax runoff falls away from the image (and drops into a collection tray 74 if desired). Said heated/etching stylus 70 should provide enough heat which will allow the stylus to easily and smoothly be drawn through the mold making material 26 without adversely affecting the surrounding material. The effect is like drawing a “hot knife through butter”—very easy to do—which effectively reduces resistance which may hinder the “drawing process” while also conveniently removing excess wax. At lower temperatures, excess wax will be pushed up along the edges of the heated/etching stylus 70. A small buildup will not affect a resulting stamp because in the reversed material product of an eventual stamp member cast 42; in this case, the raised portions will result in minor recessions along the base of the stamp member raised portions—completely disassociated from the printing surfaces. At higher temperature settings and when using a screen system, this excess wax will melt, liquefy drop down below the level of said heat-resistant screen 72 into a wax collection reservoir. The above method also effectively provides an even and consistent hot-etching depth; this in turn will afford the required consistency of height of the raised stamping surfaces of the stamp member die). The product will render a clean, clear stamp image. Said tool 70 must be heated to an ideal temperature (perhaps, utilizing a variable heat setting) which will facilitate it moving freely through the wax but not to the extent that excess runoff of melted wax may flow back into the just etched line image . If the melted wax were to return back, it may obscure, distort, or completely fill the etch, thus, defeating the intent of an etch. In addition the heated etching/embossing tool 70 should not be too hot as to pose a danger, or health risk. Nor should it be too hot to be used by older children (one of the major consumers of this invention). Regarding the above, employing a happy medium between required heat and user friendliness can easily be found.

Referring to FIG. 5, a heat resistant etching screen 72 may be positioned under the stamp mold making material 26. Not only will such a screen withstand the temperature created from a heated tool 70, it which will also allow for proper elimination of excess wax and even provide an even resulting stamp member height, for stamping as will be detailed below. In addition as detailed above in step (3), a color-coding system may be utilized to further aid in the heated etch portion of this invention, providing a depth gauge. This could be in the form of a color coded-screen 72, or as a hue differentiated mold making material 26.

Referring to FIG. 6, liquid containment walls 34 will be required to hold liquid casting compound 38 used to create a stamp member cast made from the cured casting compound 42. The illustration demonstrates the liquid containment walls 34, and mold making material 32, of a similar size and shape so as to have their two respective parts fit so closely as be “leak-proof”. However, an equally viable alternative is to have smaller sized liquid containment walls 34 be inserted into a larger etched mold making material 32. This could be designed to be a larger sheet of mold making material 32 to be appropriately “grooved” with areas in which to insert the smaller containment wall unit 34 by the user so as to allow said liquid containment walls slide into place snugly and also drop below the surface of said mold making material 32, thereby impeding said liquid casting compound 38 from leaking out of the enclosed area. Optionally, the user can merely push said liquid containment walls 34 below the surface of the mold making material 32, thereby creating a “snug” leak-proof fit as described above.

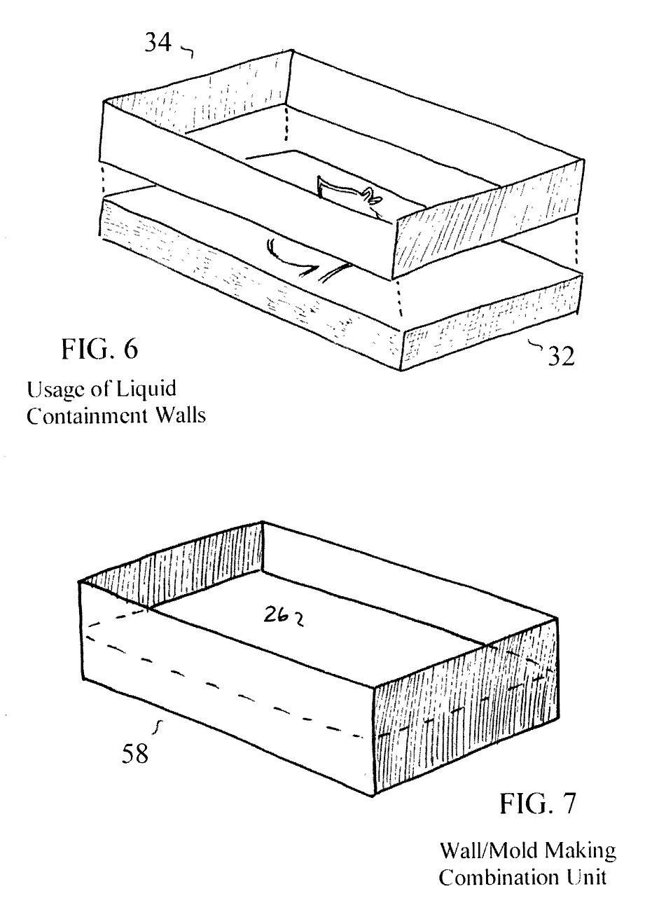

Referring to FIG. 7 a combination unit including containment walls 34 and mold making material 26, could be made as a pre-fabricated unit, a combination unit which would thereby eliminate the need for step 104 of the process (see FIG. 1, block 103-B). While this would save process time, and reduce the number of components, there would be a negligible downside where the user would then have to draw, or transfer an image and etch within the confines of a limited enclosed space.

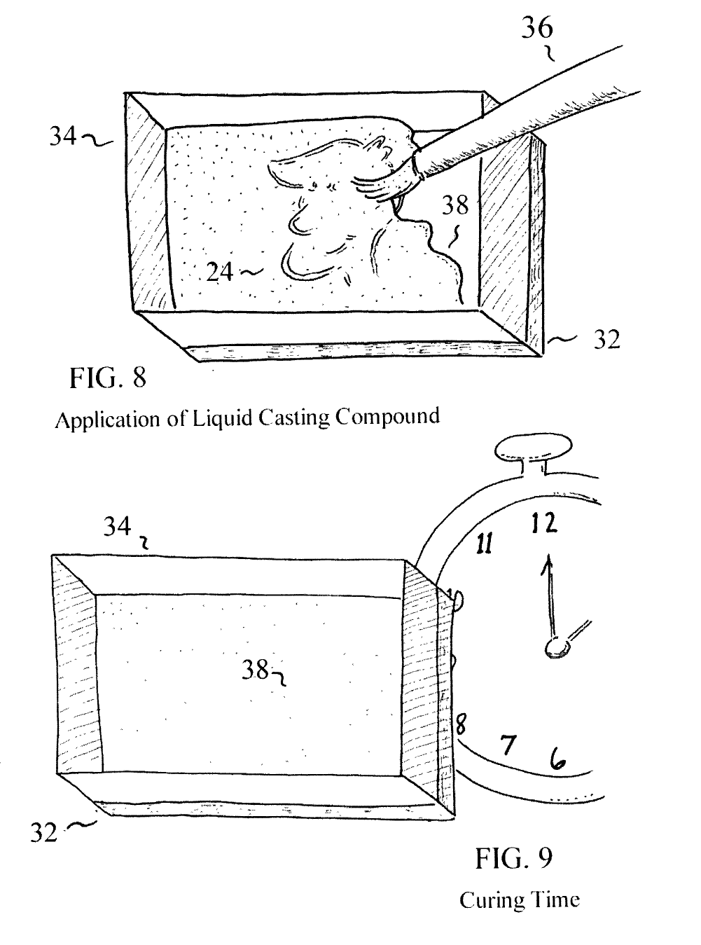

Referring to FIG. 8, this image demonstrates the application of the liquid casting compound 38. It should be noted that this illustration should be used for reference only. In reality the means of application of the liquid casting compound may depend more upon the type of compound used. Some compounds may require the tapping out of air bubbles. Others may require a succession of layers.

Referring to FIG. 9, this illustration indicates a time necessitated for curing of the liquid casting compound. Again, the amount of curing time required will change depending upon what compound is utilized in this process. Other factors, such as what, if any catalysts are employed, elevation, humidity etc. will have a direct bearing on curing time. For example, with regards to latex rubber derivatives specifically, the addition of rubbing alcohol into the mix (which pulls water molecules away during evaporation) significantly reduces the amount of curing time needed.

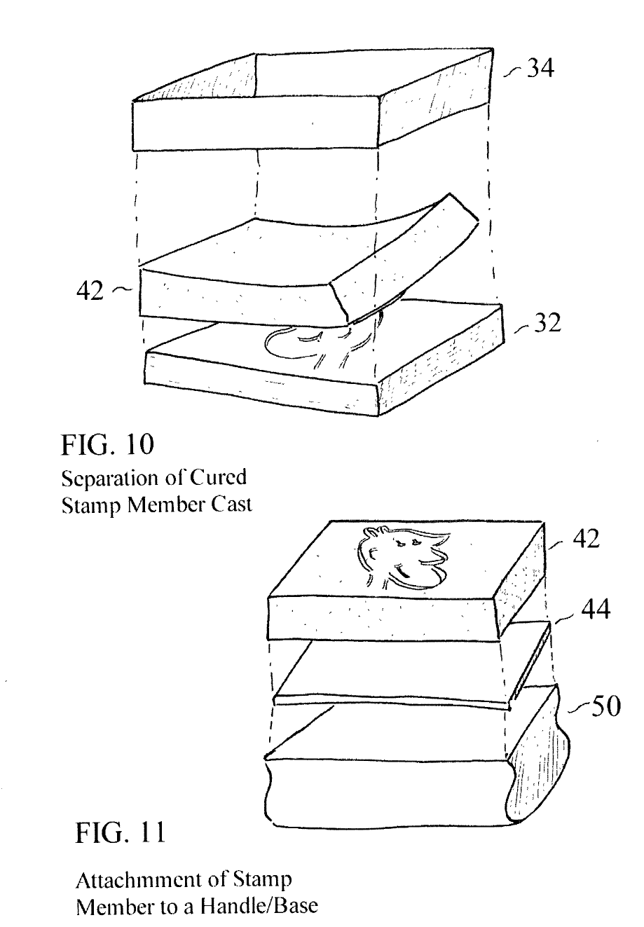

Referring to FIG. 10, this illustration shows the cured casting compound 42 being removed from the mold. This image is somewhat self explanatory. It should be noted however, that certain materials may tend to adhere and “stick” to the mold-making material 26. Again, the amount and type of adhesion, if any, depends upon what materials are used. However, some materials, such as baby powder or “buttering materials” such as grease will avoid this problem. In fact, casting materials such as Latex rubber-derivative, require very little in the form of disunion, and separate quite easily once cured. In addition, the surfaces of the liquid containment walls 34 may be milled to a high polish equaling a slick, non-stick surface.

Referring to FIG. 11, this illustration demonstrates the use of a single double-sided self adhesive strip 46 being used which will permanently position the user's stamp member to a stamp base. A double-sided adhesive element 46 provides a clean and simple means to secure the components. But this should not be considered limiting; of course, any quality adhesive means may be employed which will secure the two respective components of the stamp invention.

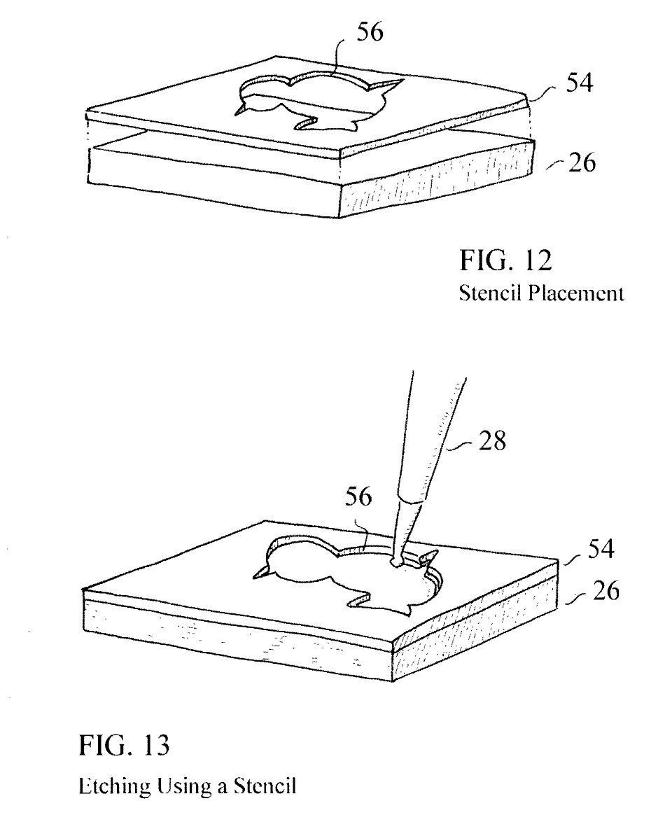

Referring to FIGS. 12 and 13, in the interest of clarity, the stencil 54 is shown merely being placed over this mold making material 26. This, is not intended to be limiting within the scope of its embodiments, but rather, an example of the stencil's general purpose. Consequently, any number of ways may be used to position and secure a drawing stencil 54 in this manner, such as sliding the stencil into place, fastening it with clamps, sliding within a groove system etc., without affecting the novelty, or altering the function of its use as employed here.

Referring to FIGS. 12 and 13, these illustrations demonstrate how a drawing stencil is utilized to create images for the etching portion of this invention. The drawing stencils 54 here are employed similarly to any drawing stencils. The user merely follows along the inner edges of the stencil openings with their etching tool 28 or 70, until the entire desired image is etched into the mold making material 26.

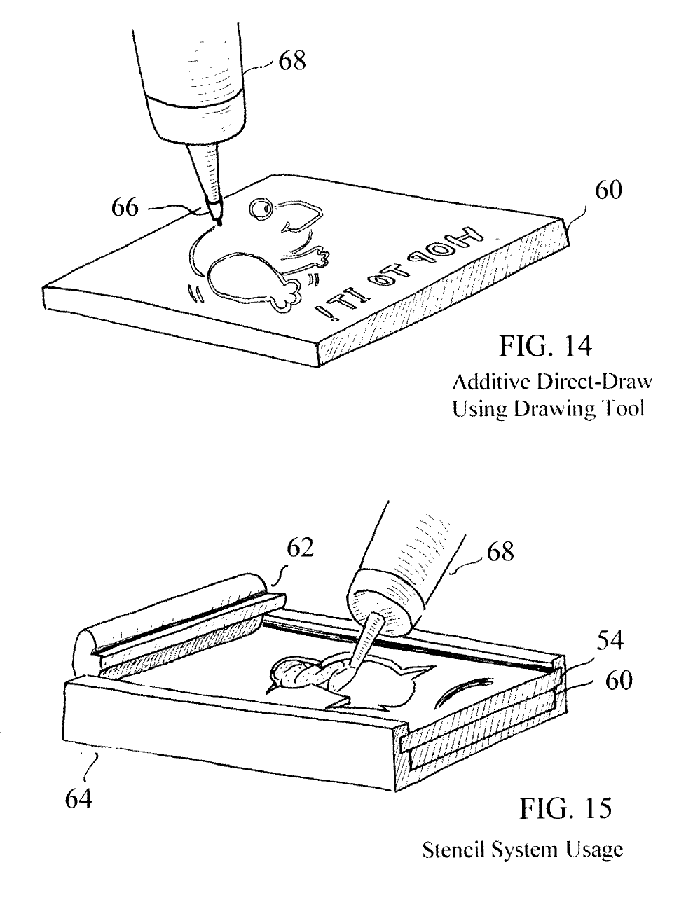

Referring to FIG. 14, the alternative method for creating a custom rubber stamp member is by additively drawing onto a stamp member surface with a three-dimensional liquid casting compound 38. One method includes using a standard craft bottle 68 and drawing craft tip 66, such as the kind used for fabric paints, crafts and glues. In this instance, the user merely squeezes the craft bottle 68, while drawing, and consequently dispenses the 3-D liquid casting compound 38 onto the rubber-like stamp member cast base 60 (with the width of the dispensed 3-D line drawn being determined solely by the size of the chosen drawing tip 66). In this process the user must maintain an even pressure and speed of movement the create even lines, as desired. It is also hypothesized that a pump system, perhaps in the form of a hand pump/pen-type stylus, can provide a steady flow of liquid casting compound 38, which will later harden to provide the raised ink retaining surfaces of a cured stamp member cast 42.

It should be noted with this 3-D additive cast making method, that any piece of text or image intended for the purpose to making a rubber stamp should either be created as a “mirror image” of the eventual stamp, or allowed to be reversed. This is due to the nature of stamping in which the image viewed on a stamp member is actually the visible ink receiving raised elements. These same raised elements of a stamp will be placed against any desired material where the ink will be transferred accordingly to result in a corrected ink image; in other words, the end product will be a mirroring of the image as seen looking down upon a original stamp member surface.

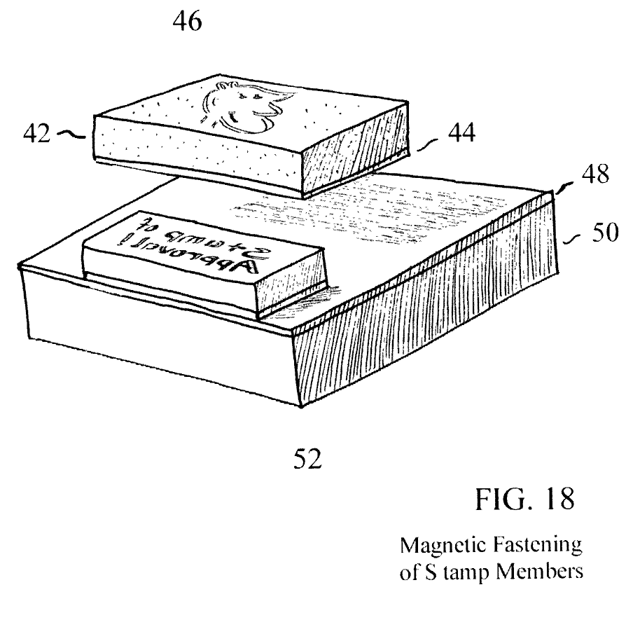

If this mirroring of the image is not desired, it can be avoided by using an image reverse transfer paper, which will reverse the image ahead of time and allow the stamped image to be “corrected” upon final stamping. A good example of this type of paper is Ditto™ paper, of the type used with Ditto™ machines, see FIG. 18, block 202. In a similar manner, appropriately placed Ditto™ paper (or any ink/graphite tinted side of paper) with its reverse image tinted side appropriately placed can be “re-drawn onto said stamp mold making material. Further, most all computer image software application, or copying machines, can easily be employed to reverse any image prior to printing.

Referring to FIG. 15 in addition to the above, the user can also make use of a stencil 54 in this method of directly drawing onto a stamp member surface. In this technique a stencil 54 is placed over the surface to be drawn upon, a rubber-like stamp member cast base 60, and the stencil opening 56 is filled with a liquid casting compound 38, which will cure and later become the raised image which will provide a stamp image. In this manner, the image of the stencil will be re-created as a 3-D raised surface and will provide an eventual reverse-image re-created on a stamp. To avoid this, the stencil need merely be turned over to its reverse orientation prior to the application of the 3-D liquid casting compound 38.

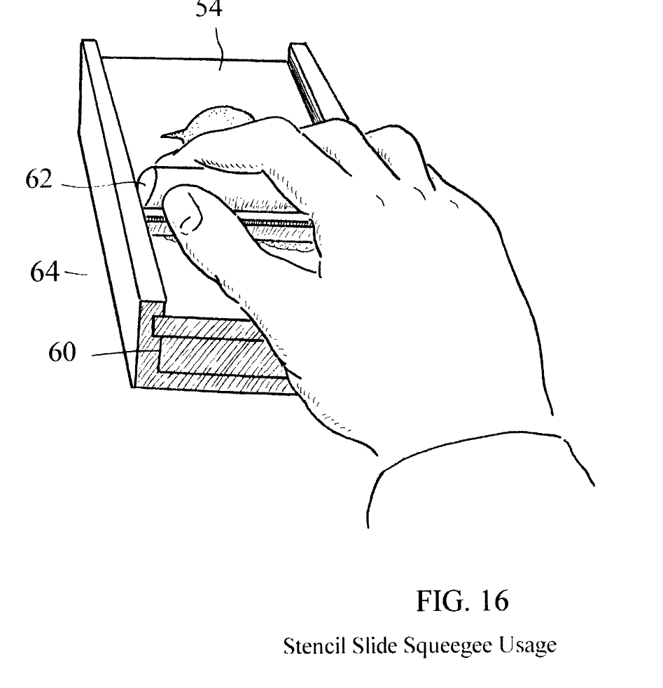

Referring to FIG. 16, a squeegee can be used to wipe clear any excess 3-D liquid casting compound 38, as well as ensure a flat depositing and curing of this material. In order to facilitate the easy removal of the stencil 56 from the cured casting material 42, it is suggested that the internal edges of the stencil cutout 56 be coated with a material which will allow for a smooth separation. Baby powder works fine with rubber cement. Again, however, those skilled in the arts will know of the most appropriate materials to use which will facilitate this need.

In addition, regarding FIGS. 15 and 16, while the illustrations indicate a combination unit of a stencil (inset in a groove system) and sliding squeegee mechanism, this should not be construed as a limiting configuration, but rather as an indication of general function.

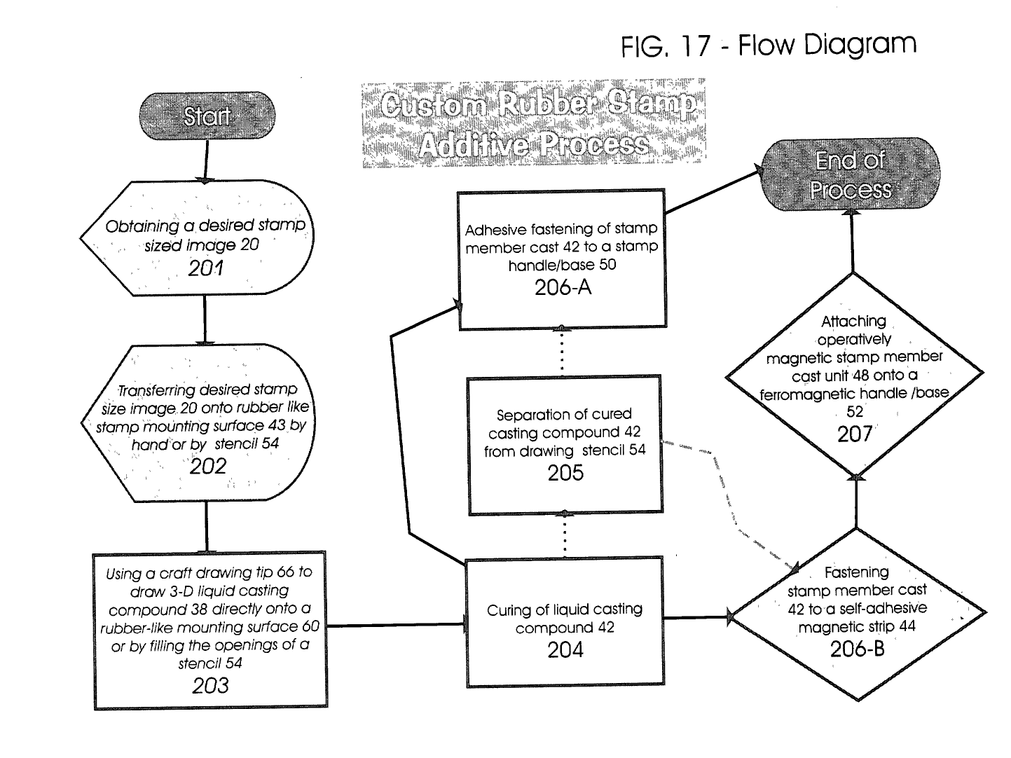

FIG. 17 illustrates a flow diagram of the preferred embodiment of an “additive process” for producing custom stamp member of this invention. According to the flow diagram in FIG. 17, the detailed steps of the preferred embodiment of the custom stamp member manufacturing process are reported as follows:

(1) obtaining a desired size stamp image 20, as shown in block 201;

(2) transferring desired stamp size image 20 onto a rubber-like stamp mounting surface 60 which will serve as a base for the applied 3-D liquid casting compound 38, as shown in block 202;

(3) using a craft drawing tip 66 to dispense the liquid casting compound 38 directly onto a rubber-like stamp member cast base 60, by direct drawing by hand, tracing over an existing image, or by filling the openings of a drawing stencil 54, as shown in block 203;

(4) curing of said casting compound 42 as shown in block 204;

(5) if necessary, separating the cured casting compound 42, hereby referred to as the stamp member cast 42, from the drawing stencil 54, as shown in block 205;

(6) fastening the stamp member cast 42 to a stamp handle base 50; as shown in block 206-A;

The following process modification should be noted:

a. The user may desire to fasten the stamp member cast 42, to a self-adhesive magnetic strip 44; this resulting operatively magnetic stamp member cast 48, can then be removably attached to a ferromagnetic metallic handle—a combination of units 48 and 50—an operatively ferromagnetic handle /base 52; While this will increase the amount of steps involved in the process, it will also allow the rubber stamp to gain the advantages of repositionability, removability and any benefit afforded a magnetic attachment, as shown in blocks 206-B and 207;

Referring to FIG. 18, this is a visual representation of the highly useful and endorsed alternative embodiment of fastening rubber stamp elements magnetically to the stamp handle/base. As one can imagine, the users of this stamp creation process may find many highly useful benefits from a flexible, magnetic fastening of resulting rubber stamp members, not the least including: ease of use, removablility, interchangeability, repositionability, combinability, and simplicity. It should be noted that demonstrating this aspect through a single illustration referring to magnetic adjustability is weak, at best. It is only hoped that the reader of this patent application can see the advantage of creativity and flexibility in stamping that utilizing a magnetic means of reposition that this invention demonstrates. Please see U.S. Pat. No. 09/465,997 (MAGNETIC STAMP MEMBER HOLDING AND POSITIONING DEVICE) which fully details this form of adhesive bonding of stamp parts and its advantages.

If, however, the user of this stamp invention process does not wish to exploit the advantages of a magnetic fastening in this invention, they simply have to adhere their custom stamp member cast 42 to a stamp handle 50 using any typical adhesive.

### SUMMARY OF INVENTION

The following is a summary of the overall steps of the invention process in detail including alternative variations ans preferred embodiments.

In sum, this invention is a method for producing a custom rubber stamp member by dispensing liquid casting compound the form of a desired image; this method utilizes either an incisive etching/mold making process, or a method of additively drawing 3-D casting material directly to a rubber-like stamp member base;

An incisive method for producing a custom rubber stamp member includes the following steps: (1) obtaining an a desired image of intended stamp size as needed (2) transferring the correct size image onto a malleable stamp mold making material by using a transfer method as needed; (3) etching into said stamp mold making material with an engraving/etching tool; (4) inserting liquid containment walls into said mold making material; (5) applying liquid casting compound to the mold making material; (6) curing of said casting compound; (7) removing the cured stamp cast from the stamp mold making material; (8) fastening the stamp member cast stamping base/handle;

An additive 3-D method for producing a custom rubber stamp member includes the following steps: (1) obtaining an a desired image of intended stamp size as needed (2) transferring the correct size image onto rubber-like stamp member base by using a transfer method as needed (3) utilizing a drawing and dispensing tool to directly apply three-dimensional liquid casting compound onto a rubber-like stamp member base; (4) curing of said casting compound; (5) fastening the stamp member cast stamping base/handle;

Furthermore, with either the incisive or additive versions, the user can alternatively fasten the cured stamp cast to a magnetic strip and then connect this operatively magnetic rubber stamp member cast to a magnetic or ferromagnetic stamping base/handle, thus making the entire rubber stamp effectively magnetic with all of the benefits a magnetic fastening will provide.

The following adjustments in the incisive process should be noted for those who wish to either (A) use a combination unit of liquid containment walls and mold making material, (B) etch directly into said mold making material, (C) to use a drawing stencil.

A. If the user wishes to use a combination unit of liquid containment walls and mold making material, then step four (4) will be eliminated (with the subsequent steps numbered accordingly).

B. If the user wishes to directly etch into said mold making material without the use of any prior image, then the process will begin at step three (3) (with the subsequent steps numbered accordingly).

C. If the user wishes to use a drawing stencil to etch an image, then user begins the stamp manufacturing process at step three (3), where the stencil provides the original desired stamping image (with the subsequent steps numbered accordingly).

Version B and C above can also utilize a combination unit of liquid containment walls and mold making material, however for simplicities sake, the ensuing descriptions will not be described at length.

The following adjustment in the additive process should be noted for those who wish to (D) combine both direct drawing of liquid mold making material with a drawing stencil:

D. If the user wishes to directly apply said 3-D liquid mold making material with a drawing/dispensing tool and a stencil, then said user begins the process at step number three (3), but this time the user simply fills a drawing stencil with said mold making material (after which he/she can level said material with a squeegee). Last, there is the additional step of separating the cured casting compound from the drawing stencil (with all steps numbered accordingly).

### DETAILED DESCRIPTION SHOWING ALTERNATE EMBODIMENTS

A viable alternative to physical etching into the mold making medium includes a safe chemical etching which will easily etch through the casting material provided that the process is timely and does not produce potentially harmful reactions. For illustration, one such example would be natural dissolving of soap in water, which provides a harmless chemical process which can be speeded up through either a physical agitation, heating of the water, or a combination of both. The mold making material, soap in this case, would have to be covered in a thin layer of a resist-material (water-proof material) which can be easily drawn into, is relatively unaffected by low heat, yet will facilitate a direct chemical etching, such as the kind produced in intaglio art prints. In this manner the very thin uppermost layer of said material is easily drawn through and the chemically reactive mold making material (water soluble soap) can be “etched” into when submerged in an etching bath (water) of the type described above. The etched soap-like material can be inverted (and agitated in the liquid) to allow gravity to create a uni-directional etching as the soap particles dissolves away and drop horizontally from material into the water. Although the above describes using a soap-like substance to be chemically etched into, this is not meant to be limiting; rather, it is intended to illustrate more clearly how this useable alternative etching process may be employed. Again those skilled in the arts will know the way. After the material is etched it should be dried and then the groove portions can be filled in with liquid casting compound 38 as described above for the regular incisive portion of this patent.

Conclusion, Ramifications and Scope of Invention

Thus, the reader will see that the adjustable custom rubber stamp member creating process provides a highly enjoyable, easy to use, non-toxic, safe and economical means of

Thus, the reader will see that the adjustable custom rubber stamp member creating process provides a highly enjoyable, easy to use, non-toxic, safe and economical means of transforming virtually any line or shape image into a high quality rubber stamp that can be used of by persons of almost any age. It also affords a means of creating a virtually unlimited variety of rubber stamps for the user. In addition, this custom stamp creating process allows one to be able to become involved with the stamp creation process, and to be able to design and create one's own image on a stamp, thereby increasing the user's sense of pride and ownership of their custom stamps.

While the above description contains many specifics, these should not be construed as limitations on the scope of the invention, but rather as an exemplification of preferred embodiments thereof. Many other variations are possible. For example, while the illustrations seem to indicate a general rectangular shape used in this stamp creating process, any shape will work equally well, as long as all the parts have matching, or corresponding shapes, or be sized, so as to provide a proper fit; it should also keep liquids from leaking out. Indeed, those skilled in the art would be able fashion any number of alternative forms and shapes and still retain the essence of my invention.

With my invention I claim the following:

1. A method for producing a stamp comprising the steps of:
(a) obtaining a desired image of intended stamp size as needed;
(b) image transfer means for transferring said image onto a stamp unit as needed;
(c) preparing a stamp unit for the application of cast making material;
(d) means of applying cast making material to said stamp unit;
(e) curing of said cast making material;
(f) separation of cured cast making material from stamp unit as needed;
(g) fastening of cured cast material to an operative stamping base.

2. An incisive method for producing a stamp of claim 1c, wherein said stamp unit is a malleable substance which is readily etched into.

3. An additive method for producing a stamp of claim 1c, wherein said stamp unit is a rubber-like substance which will have cast making material superficially applied to it.

4. An incisive method claim 1c wherein preparing a stamp unit includes etching into said stamp mold making material;

5. An incisive method for producing a stamp of claim 1d, wherein said means of applying cast making material consists of depositing cast making material into etched portions, above and beyond the thickness of etched mold making material;

6. An additive method for producing a stamp of claim 1d, wherein said means of applying cast making material is by applying a three-dimensional raised stamp member casting material superficially onto a rubber-like stamping base.

7. A general method for producing a stamp of claim 1a, wherein the method of obtaining a desired image of intended stamp size is by hand.

8. A general method for producing a stamp of claim 1b, wherein said image transfer means is by standard image duplication processes.

9. A general method for producing a stamp of claim 1b, wherein said image transfer means is a transfer paper.

10. A general method for producing a stamp of claim 1b, wherein said image transfer means is a stencil.

11. A general method for producing a stamp of claim 8, wherein said standard image duplication process is a copier.

12. A general method for producing a stamp of claim 8, wherein said standard image duplication process is a computer printer.

13. A general method for producing a stamp of claim 9, wherein said transfer paper has a physically transferable pressure-released tint coating on the opposite side of the operative drawing side of the paper.

14. A general method for producing a stamp of claim 9, wherein said is transfer paper is standard Ditto™ Paper.

15. A incisive method for producing a stamp of claim 2, wherein said malleable substance is a soap-like substance.

16. A incisive method for producing a stamp of claim 2, wherein said malleable substance is a wax-like substance.

17. A incisive method for producing a stamp of claim 2, wherein said malleable substance is hybrid mixture of wax and soap.

18. A incisive method for producing a stamp of claim 2, wherein said malleable substance is a hybrid mixture of plaster and wax.

19. A incisive method for producing a stamp of claim 2, wherein said malleable substance is a hybrid mixture of plaster and soap.

20. A incisive method for producing a stamp of claim 4 wherein a drawing stencil is used to guide the lines etched lines of etching into the mold making material.

21. A incisive method for producing a stamp of claim 4, wherein the depth of the etched lines are maintained by a system of dissimilar layer densities.

22. A incisive method for producing a stamp of claim 4, wherein depth changes of the etched lines are signaled by a system of contrasting colored layers.

23. A incisive method for producing a stamp of claim 4, wherein depth of etched lines of the malleable mold making material are rendered level utilizing a barrier plane.

24. A incisive method for producing a stamp of claim 16 wherein a heated drawing mechanism is used to create the etched lines of the wax-based mold making material.

25. A incisive method for producing a stamp of claim 16 wherein a heat resistant drawing stencil is used to guide the lines etched lines of etching into the wax-based mold making material.

26. A incisive method for producing a stamp of claim 16 wherein depth of etched lines of the wax-based mold making material are rendered level utilizing a heat resistant barrier screen device.

27. An additive method for producing a stamp of claim 3, wherein said rubber-like substance is a rubber derivative.

28. An additive method for producing a stamp of claim 3 wherein said cast making compound is a latex rubber derivative.

29. An additive method for producing a stamp of claim 27, wherein the curing of said latex rubber derivative is speeded up by adding rubbing alcohol to the curing mixture.

30. An additive method for producing a stamp of claim 1d, wherein means of applying cast making material is accomplished by dispensing said stamp member material through a drawing tip.

31. An additive method for producing a stamp of claim 1d, wherein means of applying cast making material is accomplished by filling an overlaid stencil.

32. An additive method for producing a stamp of claim 31 wherein the surface material of the applied cast making material within a stencil is rendered level utilizing a squeegee device.
